(19) United States
(12) Patent Application Publication
(10) Pub. No.: US 2019/0098107 A1
(43) Pub. Date: Mar. 28, 2019

(54) GEOGRAPHIC LOCATION BASED USER COMPUTING ASSET PROVISIONING IN DISTRIBUTED COMPUTING SYSTEMS

(71) Applicant: Microsoft Technology Licensing, LLC, Redmond, WA (US)

(72) Inventors: Amy Howard, Kirkland, WA (US); Sergiy Gavrylenko, Issaquah, WA (US); Adriana Wood, Woodinville, WA (US); Roberto Taboada, Duvall, WA (US); Hongzhou Ma, Redmond, WA (US); Seshadri Mani, Redmond, WA (US); Vijaya Chidambara Babu Nelson, Bangalore (IN); Kolvekar Loveleen Ramachandra, Bangalore (IN); Ravi Kanth Nagavarapu, Hyderabad (IN); Brian Lee Van Eimeren, Kirkland, WA (US)

(21) Appl. No.: 16/013,696

(22) Filed: Jun. 20, 2018

(30) Foreign Application Priority Data
Sep. 22, 2017 (IN) 201741033769

(51) Int. Cl. H04L 29/08; H04L 12/24

(52) U.S. Cl. CPC H04L 67/2838; H04L 67/10; H04L 67/18; H04L 41/0806

(57) ABSTRACT

Distributed computing systems, computing devices, and associated methods of operations implementing geographic location based computing asset provisioning are disclosed herein. In one embodiment, a provisioning server is configured to retrieve, from a directory service, a record of user account data containing data representing a pre-configured deployment location at which user data of the requested computing service is to be stored. The provisioning server is also configured to determine whether a current geographic location of the provisioning server is within a geographic boundary of the deployment location and in response to determining that the current geographic location of the provisioning server is within a geographic boundary of the deployment location, deploy computing assets at the current geographic location to allow user data of the computing service to be stored at the pre-configured deployment location to satisfy data residency regulations.

### CROSS-REFERENCE TO RELATED APPLICATION(S)

This application claims priority to Indian Patent Application No. 201741033769, filed on Sep. 22, 2017, the disclosure of which is incorporated herein in its entirety.

### BACKGROUND

Corporations, schools, charities, government offices, and other types of enterprises often deploy private computer networks commonly referred to as intranets. Such intranets can allow users of an enterprise to securely share information within the enterprise. For example, an intranet can include a file management system that is configured to store, track, or otherwise manage internal documents of an enterprise. In contrast, the term “internet” typically refers to a public computer network among individuals and enterprises. One example internet contains billions interconnected of computer devices worldwide based on the TCP/IP protocol, and is commonly referred to as the Internet.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Intranets can provide users of an enterprise ability to collaborate with one another. For example, users of the enterprise can create and share with one another a site dedicated to, for instance, a project, team, department, etc. Users of a project, team, department can then share documents, drawings, or interact with one another via the site. However, such collaboration may be difficult when an intranet is segregated due to location conditions. For example, different countries, regions, or geographic locations may have different requirements regarding data residency for privacy, security, national interest, law enforcement, censorship, or other suitable reasons. For instance, one country may require all communications data to be stored within its borders, and not on servers located abroad.

To accommodate such requirements, in certain implementations, different instances of the same intranet can be deployed at servers in different geographic locations to ensure that data is maintained in each geographic boundary. For example, one instance of the intranet can be deployed in the United States while another deployed in China. The two instances of the intranet, however, behave as if being separate computing systems. As such, users of the same enterprise at different geographic locations may experience difficulty for collaborating on projects or other suitable tasks. Also, the separate instances can limit a user's ability to deploy computing assets in a geographic location (e.g., in China) when the user uses an entry point at a different geographic location (e.g., in the United States).

Several embodiments of the disclosed technology can address at least certain aspects of the foregoing difficulty by implementing a provision server that uses a user's deployment location to determine placement and storage of computing assets for the user in order to meet data residency requirements of multi-national companies or other types or organizations. In certain embodiments, the provisioning server (or service) can be configured to receive a request from a user of an organization for initiating or deploying a computing service (e.g., a group site or mailbox for a project).

In response, the provisioning server can be configured to query and receive data representing a deployment location corresponding to the user from, for instance, a directory service. The provisioning server can then determine computing assets needed for the requested computing service (e.g., servers, virtual machines, network storage spaces, network bandwidth, etc.) at the deployment location and initiate a provisioning process at the deployment location for the user. As such, users of the enterprise can have access to the same intranet and collaborate with one another while data residency requirements are met. Also, several embodiments of the disclosed technology can allow a user to deploy computing assets at the deployment location regardless of the user's entry point or physical geographic location. Thus, a user can be physically located in the United States and requests deployment of a virtual machine on a server located in China.

### BRIEF DESCRIPTION OF THE DRAWINGS

FIG. 1 is a schematic diagram illustrating a distributed computing system implementing geographic location based computing asset provisioning in accordance with embodiments of the disclosed technology.

FIGS. 2A and 2B are schematic diagrams illustrating example operations of the distributed computing system 100 in FIG. 1 for deploying computing services for users 101 in multiple geographic locations in accordance with embodiments of the disclosed technology.

FIG. 3 is a schematic diagram illustrating certain hardware/software components of the provisioning server in FIG. 1 in accordance with embodiments of the disclosed technology.

FIGS. 4A and 4B are flowcharts illustrating certain processes of geographic location based computing asset provisioning in a distributed computing system in accordance with embodiments of the disclosed technology.

FIG. 5 is a computing device suitable for certain components of the computing system in FIG. 1.

### DETAILED DESCRIPTION

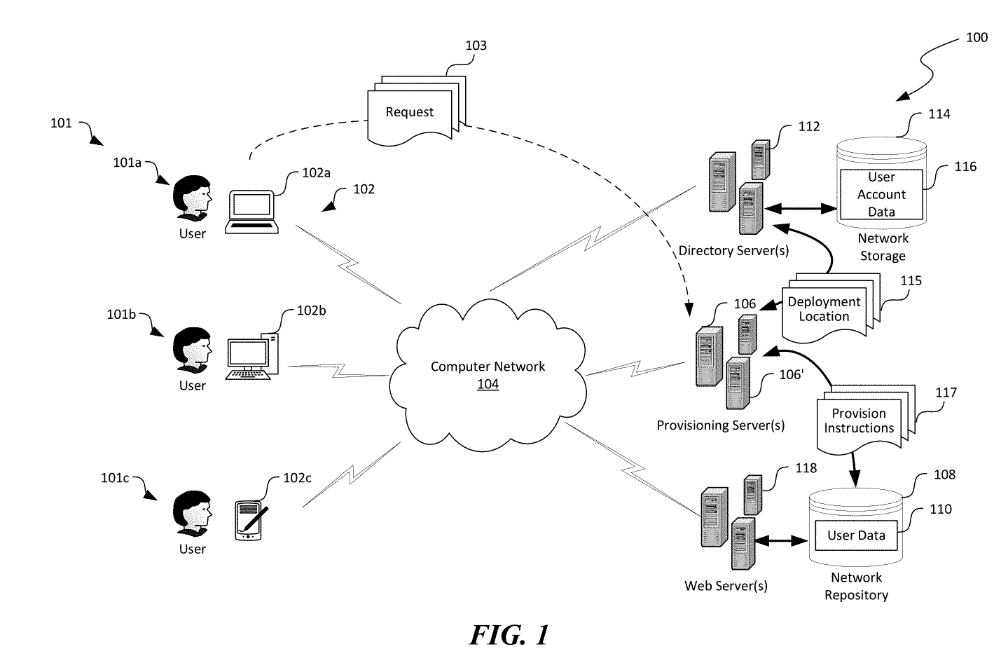

Certain embodiments of systems, devices, components, modules, routines, data structures, and processes for geographic location based computing asset provisioning are described below. In the following description, specific details of components are included to provide a thorough understanding of certain embodiments of the disclosed technology. A person skilled in the relevant art will also understand that the technology can have additional embodiments. The technology can also be practiced without several of the details of the embodiments described below with reference to FIGS. 1-5.

As used herein, a “distributed computing system” generally refers to an interconnected computer network having a plurality of network devices that interconnect a plurality of servers or hosts to one another or to external networks (e.g., the Internet). At least some of the servers or hosts can be located in, for example, different datacenters at diverse geographic locations. The term “network device” generally refers to a physical network device, examples of which include routers, switches, hubs, bridges, load balancers, security gateways, or firewalls. A “host” generally refers to a computing device configured to implement, for instance, one or more virtual machines or other suitable virtualized components. For example, a host can include a server having a hypervisor configured to support one or more virtual machines or other suitable types of virtual components.

Also used herein, the term “system resource” or “computing asset” generally refers to any physical or virtual component of limited availability within a distributed computing system. Example computing assets can include processor capacities (e.g., CPU), network capacities (e.g., network connections and network bandwidth), and computer readable storage capacities (e.g., memory blocks in solid state devices). Executing an application in a computer system can consume various amount of computing assets. For example, executing an application for voice-over-IP conference can consume an amount of computing and network assets. In another example, executing an application of database management can consume an amount of processor capacities and storage capacities.

Also used herein, a “computing service” generally refers to computing resources provided over a computer network such as the Internet. Common examples of cloud services include software as a service (“SaaS”), platform as a service (“PaaS”), and infrastructure as a service (“IaaS”). SaaS is a software distribution technique in which software applications are hosted by a cloud service provider in, for instance, datacenters, and accessed by users over a computer network. PaaS generally refers to delivery of operating systems and associated services over the computer network without requiring downloads or installation. IaaS generally refers to outsourcing equipment used to support storage, hardware, servers, network devices, or other components, all of which are made accessible over a computer network.

Also used herein, the term “account” or “user account” generally refers to a collection of data associated with a particular user or a group of users in a multi-user computer system and/or computing service. The collection of data or “user account data” allows a user to authenticate to the computer system and/or computing service and to access resources provided by the computer system and/or computing service. Examples of user account data include (i) a username, a login name, a screenname, a nickname, a handle or other suitable user identifier and (ii) a password, a secret answer, a digital key, or other suitable types of credential data.

A user can identify him/herself with the user identifier and authenticate to a computer system and/or computing service with the credential data. Once authenticated, access to certain computing resources (e.g., other user accounts or stored content) can be granted to the user. In certain embodiments, a user can have multiple user accounts, for example, by registering with a computer system or computing service with multiple user identifiers. In other embodiments, multiple users can have a single group account, for example, by sharing a set of username and credential data. In further embodiments, multiple users can individually have one or more user accounts.

In certain embodiments, user account data of a user can also include data indicating a preferred geographic location (referred to herein as a “deployment location”) for deploying various computing assets for the user. The deployment location of a user can be the same or different than a physical location at which the user is located. For example, the user can be physically located in the United States while his/her deployment location is in Europe, China, or other different geological locations. As described in more detail below, several embodiments of the disclosed technology are directed to provisioning various computing assets for a user-requested computing service/object in accordance with the collection of data containing the deployment location for the user. In other embodiments, the data of deployment locations can be contained in a separate database than the collection of data containing user credentials, etc.

Further used herein, the term “provisioning” generally refers to a set of preparatory actions for deploying or providing a user requested computing service in a distributed computing system. For example, provisioning can include allocating various types of computing assets to the requested computing service, for example, by allocating storage space and placing a configuration file of a user requested site in the allocated storage space of a content database, activating a requested list of desired features for the site, appropriately securing the site, and providing access to the site over a computer network. In another example, provisioning can also include selecting one or more servers from a pool of available servers in datacenters, computing clusters, or other computing facilities. As described in more detail below, several embodiments of the disclosed technology allow selection of the one or more servers based on the deployment location of the user requesting the computing service.

Provisioning can further include locating and providing access to images of operating systems, device drivers, middleware, applications, or other suitable software components related to the cloud services. The images of the software components can then be configured to generate a boot image for the selected servers. Provisioning can further include assigning IP addresses, IP Gateways, virtual networks, DNS servers, or other network parameters to the selected servers and/or executed software components. The servers can then load and execute the software components in order to provide the requested features of the site.

Intranets can provide users of an enterprise ability to collaborate with one another. For example, users of the enterprise can create and share with one another a site dedicated to, for instance, a project, that allows users of the project to share documents, drawings, or interact with one another. However, such collaboration may be difficult when an intranet is physically segregated due to location conditions such as local laws and regulations. For example, different countries, regions, or geographic locations may have different requirements regarding data residency for privacy, security, national interest, law enforcement, censorship, or other suitable reasons. For instance, one country may require all communications data to be stored within its borders, and not on servers abroad.

To accommodate such requirements, in certain implementations, different instances of the same intranet can be deployed at servers located in different geographic locations to ensure that data is maintained in a geographic boundary. For example, one instance of the intranet can be deployed in the United States while another deployed in China. The two instances of the intranet, however, behave as they are separate computing systems. As such, users of the same enterprise at different geographic locations may experience difficulty for collaborating on projects or other suitable tasks. Also, the separate instances can also limit a user's ability to deploy computing assets in a geographic location when the user uses an entry point at a different geographic location.

Several embodiments of the disclosed technology are directed to a provisioning server configured to use a user's deployment location to determine placement of computing assets for the user in order to meet data residency requirements of multi-national companies or other suitable types or organizations. In certain embodiments, the provisioning server (or a cloud service) can receive a request from a user for initiating or deploying a computing service (e.g., a group site or mailbox for a project). In response, the provisioning server can be configured to query and receive data representing a pre-configured deployment location of the user from, for instance, a directory service (or a directory server). The provisioning server can then determine computing assets needed for the requested computing service (e.g., servers, network storage spaces, network bandwidth, etc.) at the deployment location and initiate a provisioning process at the deployment location for the user. As such, users of the enterprise can have access to the same instance of the intranet and collaborate with one another while data residency requirements for individual localities are satisfied. Also, several embodiments of the disclosed technology can allow a user to deploy computing assets at the pre-configured deployment location regardless of the user's entry point or physical geographic location.

Additional embodiments of the disclosed technology are directed to synchronizing and tracking data representing user deployment locations from a central system (e.g., the directory service) to various applicable provisioning servers, services, or pipelines. For example, the directory service can share with a mailbox provisioning server data representing the deployment location of the user for creating a mailbox requested by the user. Once the mailbox is provisioned, the mailbox provisioning server can update the directory service the deployed computing assets and corresponding geographic locations. In further embodiments, different provisioning servers or services may notify one another of computing asset provisioning to expedite asset creation before synchronization occurs, as described below with reference to FIGS. 1-5.

FIG. 1 is a schematic diagram illustrating a distributed computing system 100 implementing geographic location based computing asset provisioning in accordance with embodiments of the disclosed technology. As shown in FIG. 1, the distributed computing system 100 can include a computer network 104 interconnecting client devices 102 corresponding to users 101, a provisioning server 106, a directory server 112, and one or more web servers 118. The computer network 104 can include an enterprise intranet, a wide area network, the Internet, or other suitable types of network.

The distributed computing system 100 can also include a network repository 108 operatively coupled to the web servers 118 and a network storage 114 operatively coupled to the directory server 112. As shown in FIG. 1, the network repository 108 can be configured to store records of user data 110 accessible to the users 101 via the client devices 102 and the computer network 104. The user data 110 can include any suitable application data created, used, or otherwise accessible to the users 110. For example, examples of the user data 110 can include documents, images, videos, or other suitable types of files.

The network storage 114 can be configured to store records of user account data 116. Example user account data 116 include user names, user locations, user alias, user pictures, user contact information, access control credentials, and/or other suitable types of data. In accordance with embodiments of the disclosed technology, the user account data 116 can also include data representing a pre-configured deployment location for each of the users 101. The deployment location can identity a geographic region (e.g., the European Union), a country (e.g., Ireland), a state/province (e.g., Connacht), a county (e.g., Roscommon), a city (e.g., Dublin), a datacenter, one or more racks in a datacenter, or other suitable location. In certain embodiments, an administrator (not shown) can configure the deployment location for each user 101 when the user account data 116 is created and/or modified. In other embodiments, the deployment location for each user 101 can be automatically set, at least initially, to a default physical geographic location of the user 101. In further embodiments, the deployment location can be set, reset, or modified in other suitable manners.

Even though particular components and associated arrangements of the distributed computing system 100 are shown in FIG. 1, in other embodiments, the distributed computing system 100 can include additional and/or different components. For example, in certain embodiments, the network repository 108 and the network storage 114 can be combined into a single physical or logical storage space accessible via the computer network 104. In further embodiments, the distributed computing system 100 can also include additional servers, network storages, load balancers, or other suitable components.

The client devices 102 can individually include a computing device that facilitates access to the network repository 108 via the computer network 104 by the users 101 (identified as first, second, and third users 101a-101c, respectively). For example, in the illustrated embodiment, the first client device 102a is a laptop computer. The second client device 102b is a desktop computer. The third client device 102c is a tablet computer. In other embodiments, the client devices 102 can also include smartphones, tablets, or other suitable computing devices. Even though three users 101a-101c are shown in FIG. 1 for illustration purposes, in other embodiments, the distributed computing system 100 can facilitate any suitable number of users 101 access to the network repository 108 via the computer network 104.

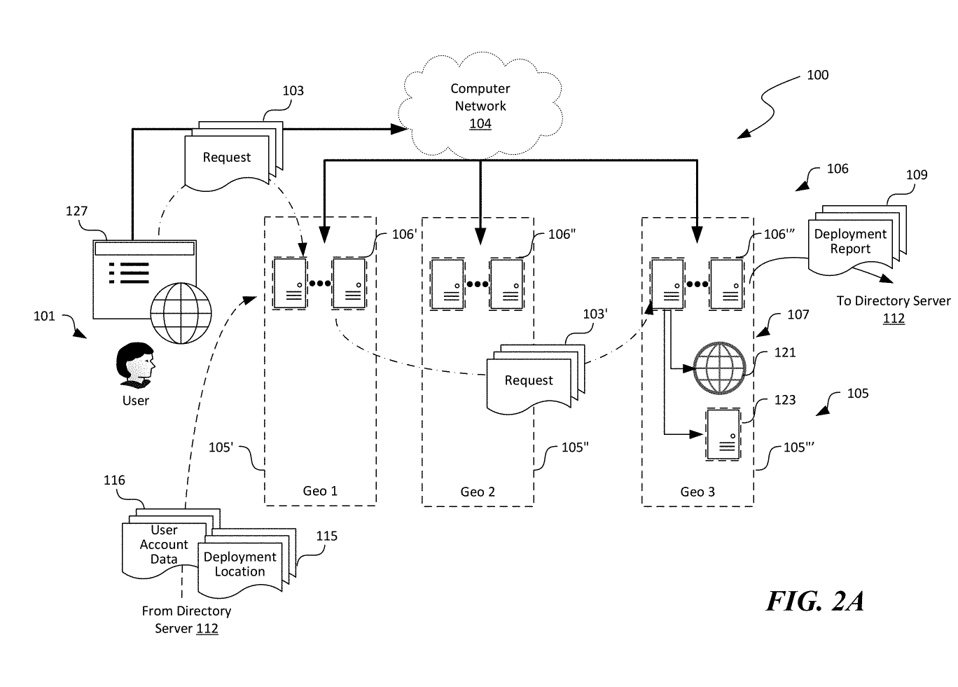

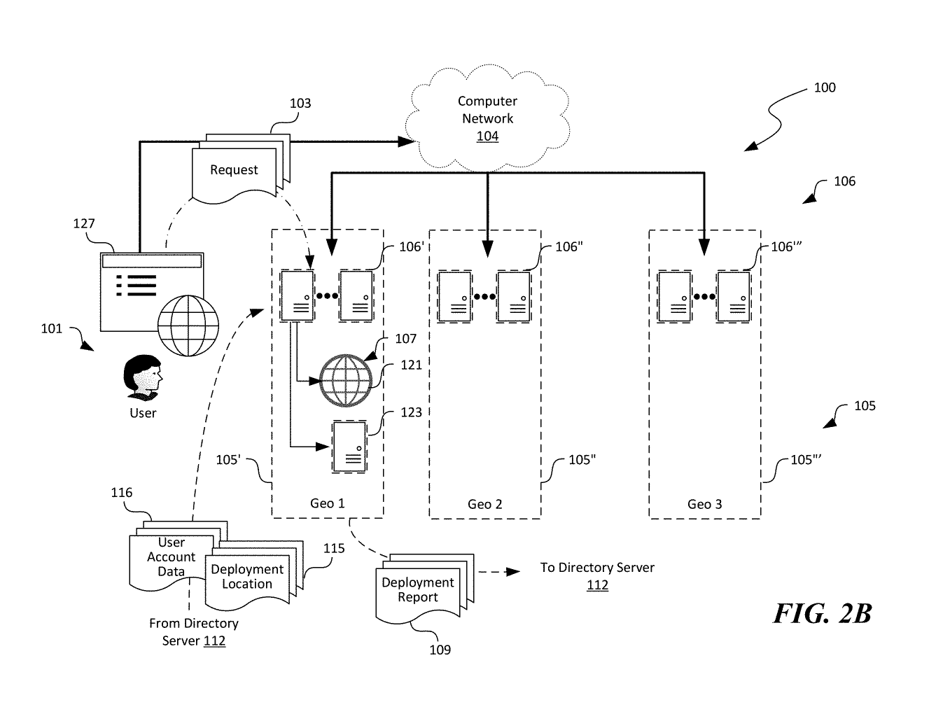

In certain embodiments, the provisioning server 106, the directory server 112, and the web servers 118 can each include one or more interconnected computer servers, as shown in FIG. 1. Each of the provisioning server 106, the directory server 112, and the web servers 118 can be located in different geographic locations, as described in more detail below with reference to FIG. 2. In other embodiments, the foregoing components of the distributed computing system 100 can each include a cloud-based service hosted on one or more remote computing facilities such as datacenters. In further embodiments, certain components (e.g., the web servers 118) may be omitted from the distributed computing system 100 in FIG. 1, and the corresponding functions can be provided by external computing systems (not shown).

The web servers 118 can be configured to provide one or more websites or “sites” accessible by the users 101 via the computer network 104. For example, in one embodiment, the web servers 118 can be configured to provide an enterprise internal website that allows the users 101 to securely exchange information and to cooperate on performing tasks or executing a project. In other embodiments, the web servers 118 can also be configured to provide a social network website that allows the users 101 to post user data 110, comment on one another's user data 110, share and/or recommend user data 110 with additional users 101, or perform other suitable actions. In certain embodiments, the web servers 118 can also be configured to receive and store the user data 110 in the network repository 108. In other embodiments, the distributed computing system 100 can further include a database server (not shown) or other suitable components configured to perform the foregoing functions.

The directory server 112 can be configured to maintain the user account data 116 for the users 101 and facilitate various account related operations, such as access control, data queries, etc. For example, in one embodiment, the directory server 112 can implement access control policies such that certain class, type, category, or other suitable grouping of the user data 110 can be accessible to specified users 101. In another embodiment, the directory server 112 can also be configured to share with various provisioning servers 106 data representing the deployment locations of the various users 101.

The provisioning server 106 can be configured to provision various computing assets in order to provide or deploy computing services requested by the users 101. In certain embodiments, the provisioning server 106 can be configured to receive a request 103 for a computing service, object, or other suitable types of computing entity from a user 101. In response, the provisioning server 106 can receive data representing the deployment location 115 corresponding to the requesting user 101 and initiate a provisioning process based on the received deployment location 115 of the user 101 received from the directory server 112 by imputing or otherwise assigning one or more computing assets at the deployment location of the user 101 to the requested computing service.

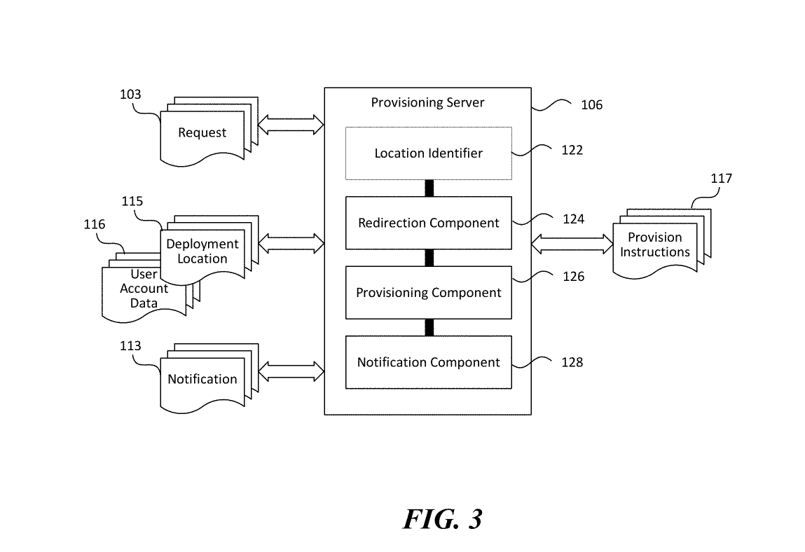

As such, when the provisioning server 106 is at the deployment location of the user 101, the provisioning server 106 can initiate the provisioning process for the computing service at the deployment location. For example, the provisioning server 106 can allocate certain storage spaces in the network repository 108 for storing corresponding user data 110 for the requested computing service by transmitting an instruction of provision instructions 117 to the network repository 108. The provisioning server 106 can also allocate compute, network, or other suitable types of assets to the requested computing service. When the provisioning server 106 is not at the deployment location of the user 101, the provisioning server 106 can be configured to forward the request from the user 101 to another provisioning server 106′ that is at the deployment location of the user 101. As such, computing assets can be allocated to the requested computing service according to the deployment location regardless where the user 101 requested the computing service, as described below in more detail with respect to FIG. 2. In further embodiments, when computing assets do not exist or are insufficient at the deployment location corresponding to the user 101, the provisioning server 106 can be configured to initiate the provisioning process at a default location previous selected by, for example, an administrator (not shown). Certain example components of the provisioning server 106 are described in more detail below with reference to FIG. 3.

FIGS. 2A and 2B are schematic diagrams illustrating example operations of the distributed computing system 100 in FIG. 1 for deploying computing services for users 101 in multiple geographic locations in accordance with embodiments of the disclosed technology. As shown in FIG. 2A, the distributed computing system 100 can include provisioning servers 106 (identified individually as first, second, and third provisioning server 106′, 106″, and 106′″ at three different geographic locations identified individually as “Geo 1” 105′, “Geo 2” 105″, and “Geo 3” 105′″, respectively. Though only three geographic locations 105 are shown in FIG. 2 for illustration purposes, the provisioning servers 106 and/or other components of the distributed computing system 100 can be at two, four, five, or any other suitable number of different geographic locations 105.

As shown in FIG. 2A, in the illustrated example, the user 101 can request, for instance, via a user portal 127, a computing service (e.g., a group site for a project) by transmitting a request 103 to the first provisioning server 106′ in the first geographic location 105′ via the computer network 104. In response, the first provisioning server 106′ at the first geographic location 105′ can query and receive the user account data 116 from the directory server 112 (FIG. 1) and identify the deployment location 115 corresponding to the user 101. The provisioning server 106 can then assign the determined deployment location 115 to the requested computing service and determine whether the current location (e.g., Geo 1 105′) is the deployment location 115.

In the illustrated example in FIG. 2A, the first provisioning server 106′ determines that the deployment location 115 is not the current location (i.e., Geo 1 105′), but instead, Geo 3 105′″. In response, the first provisioning server 106′ can be configured to forward the request 103 to the third provisioning server 106′″ at Geo 3 105′″. The third provisioning server 106′″ can then perform similar operations to determine that the requested computing service is to be deployed at Geo 3 105′″. In response, the third provisioning server 106′″ initiates a provisioning process at Geo 3 105′″ for the requested computing service 107 (shown as a website 121 and a virtual machine 123 for illustration purposes). In certain embodiments, upon completion of the provisioning process in Geo 3 105′″, the third provisioning server 106′″ can forward a deployment report 109 to the directory server 112 (or other suitable entities in the distributed computing system) for recording that computing assets are deployed at Geo 3 105′″ for the requested computing service 107.

In another example, as shown in FIG. 2B, the first provisioning server 106′ can determine that the deployment location 115 is the current location (i.e., Geo 1 105′). In response, the first provisioning server 106′ can be configured to initiates a provisioning process at Geo 1 105′ for the requested computing service 107 (shown as a website 121 and a virtual machine 123 for illustration purposes). Similarly, upon completion of the provisioning process in Geo 3 105′″, the first provisioning server 106′ can also forward a deployment report 109 to the directory server 112 (or other suitable entities in the distributed computing system) for recording that computing assets are deployed at Geo 1 105′ for the requested computing service 107.

Several embodiments of the disclosed technology can thus allow users of an enterprise to have access to the same instance of the intranet and collaborate with one another while data residency requirements for individual localities are satisfied. Also, several embodiments of the disclosed technology can allow a user to deploy computing assets at the pre-configured deployment location (i.e., Geo 3 105′″) regardless of the user's entry point or physical geographic location (i.e., Geo 1 105′).

FIG. 3 is a schematic diagram illustrating certain hardware/software components of the provisioning server 106 of FIG. 2 in accordance with embodiments of the disclosed technology. In FIG. 2 and in other Figures herein, individual software components, objects, classes, modules, and routines may be a computer program, procedure, or process written as source code in C, C++, C#, Java, and/or other suitable programming languages. A component may include, without limitation, one or more modules, objects, classes, routines, properties, processes, threads, executables, libraries, or other components. Components may be in source or binary form. Components may include aspects of source code before compilation (e.g., classes, properties, procedures, routines), compiled binary units (e.g., libraries, executables), or artifacts instantiated and used at runtime (e.g., objects, processes, threads). In certain embodiments, the various components and modules described below can be implemented with actors. In other embodiments, generation of the application and/or related services can also be implemented using monolithic applications, multi-tiered applications, or other suitable components.

Components within a system can take different forms within the system. As one example, a system comprising a first component, a second component and a third component can, without limitation, encompass a system that has the first component being a property in source code, the second component being a binary compiled library, and the third component being a thread created at runtime. The computer program, procedure, or process may be compiled into object, intermediate, or machine code and presented for execution by one or more processors of a personal computer, a network server, a laptop computer, a smartphone, and/or other suitable computing devices. Equally, components may include hardware circuitry.

A person of ordinary skill in the art would recognize that hardware may be considered fossilized software, and software may be considered liquefied hardware. As just one example, software instructions in a component may be burned to a Programmable Logic Array circuit, or may be designed as a hardware circuit with appropriate integrated circuits. Equally, hardware may be emulated by software. Various implementations of source, intermediate, and/or object code and associated data may be stored in a computer memory that includes read-only memory, random-access memory, magnetic disk storage media, optical storage media, flash memory devices, and/or other suitable computer readable storage media excluding propagated signals.

As shown in FIG. 3, the provisioning server 106 can include a location identifier 122, a redirection component 124, a provisioning component 126, and a notification component 128 operatively coupled to one another. Though only the foregoing components are shown in FIG. 3 for illustration purposes, in other embodiments, the provisioning server 106 can include interface components, communication components, or other suitable types of components. In further embodiments, the foregoing individual components of the provisioning server 106 can also be implemented as one or more computing services in the distributed computing system 100 of FIG. 1.

The location identifier 122 can be configured to identify a deployment location associated with a requested computing service to be provisioned. In one embodiment, the location identifier 122 can request, from the directory server 102 (FIG. 1), the user account data 116 of a user 101 (FIG. 1) who requested the computing service. Based on the user account data 116, the location identifier 122 can identify the deployment location 115 of the user 101 and assign the deployment location to the computing service to be provisioned.

The redirection component 124 can be configured to determine whether the computing service is to be provisioned locally at the provisioning server 106 or at a different geographic location. In certain embodiments, the redirection component 124 can be configured to compare a current location of the provisioning server 106 with the identified deployment location 115 associated with the requested computing service. In response to determining that the current location is suitable (e.g., within the geographic boundary) of the deployment location 115, the redirection component 124 can indicate to the provisioning component 126 to initiate the provisioning process. In response to determining that the current location is not suitable (e.g., not within the geographic boundary) of the deployment location 115, the redirection component 124 can be configured to forward the user request 103 to another provisioning server 106′ (not shown) that is located within the geographic boundary of the deployment location 115. Initiation of the provisioning process at the provisioning server 106 in the current location is then skipped.

The provisioning component 126 can be configured to provision various computing assets for providing the requested computing service by, for instance, transmitting provision instructions 117. For example, the provisioning component 126 can be configured to allocate network storage, computation, network communications, or other suitable types of computing assets to the requested computing service. In other examples, the provisioning component 126 can also be configured to locate and obtain images of operating systems, device drivers, middleware, applications, or other suitable software components related to the computing service. The images of the software components can then be configured to generate a boot image for the selected servers. The provisioning component can further be configured to assign IP addresses, IP Gateways, virtual networks, DNS servers, or other network parameters to the selected servers and/or executed software components. The servers can then load and execute the software components in order to provide the requested computing service.

The notification component 128 can be configured to receive and/or provide notification 113 regarding geographic locations certain requested computing services by the users 101 to be deployed. For example, in one embodiment, the directory server 102 can transmit the notification 113 regarding new or modified deployment locations for the users 101. In other embodiments, other provisioning servers 106 can transmit the notification 113 regarding computing assets deployed locally for certain computing services.

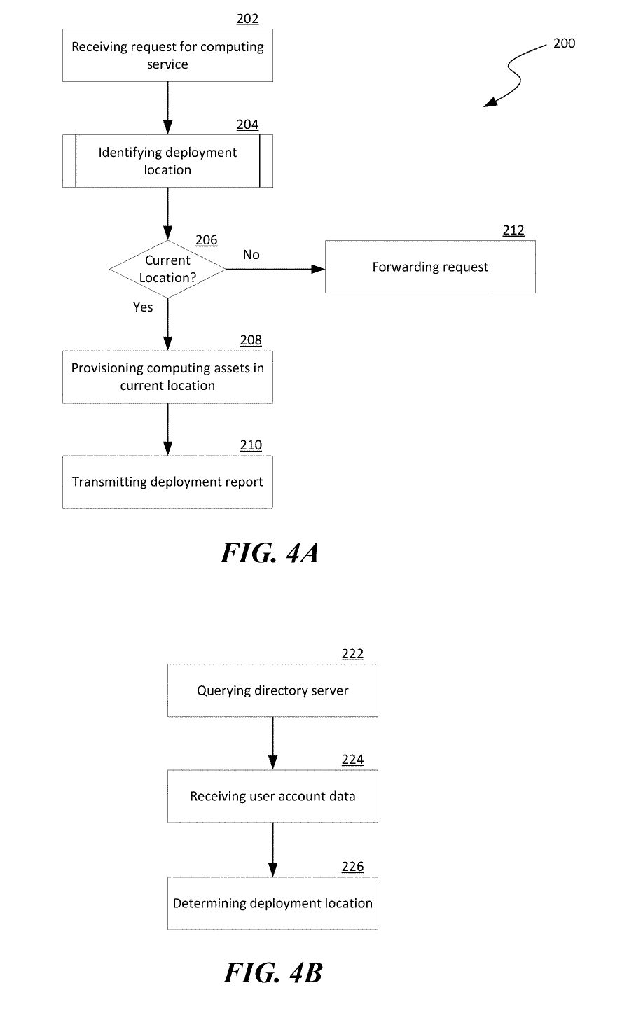

FIGS. 4A and 4B are flowcharts illustrating certain processes of geographic location based computing asset provisioning in a distributed computing system in accordance with embodiments of the disclosed technology. Even though the processes are described below in the context of the distributed computing system 100 of FIG. 1, in other embodiments, the processes may be implemented in other computing systems with additional and/or different components.

As shown in FIG. 4A, a process 200 can include receiving, at a provisioning server, a request from a user for deploying a computing service at stage 202. The user can submit the request from a geographic location at which the provisioning server is located, or from a geographic location that is different than a geographic location of the provisioning server. The process 200 can then include identifying or determining a pre-configured deployment location for requested computing service by the user at stage 204. In certain embodiments, the deployment location is pre-configured and stored as a part of user account data in a directory server or service. In other embodiments, the deployment location can be pre-configured and stored as independent data records or in other suitable forms. Example operations of determining the deployment location are described in more detail below with reference to FIG. 4B.

The process 200 can then include a decision stage to determine whether the provisioning server is within a geographic boundary of the deployment location. In one example, the provisioning server can be associated with data defining a corresponding geographic boundary (e.g., a country, a zone, a continent, etc.). Determining whether the provisioning server is within a geographic boundary can thus include comparing the defined geographic boundary with the deployment location. In other examples, the provisioning server can be associated with a specific address (e.g., identified by a street number, street, city, state, country, etc.). Determining whether the provisioning server is within a geographic boundary can thus include determining whether the address of the provisioning server is within the deployment location (e.g., a country or region of the country). In further examples, determining whether the provisioning server is within a geographic boundary can include comparing a zip code of the provisioning server with the deployment location associated with multiple zip codes, or via other suitable means.

In response to determining that the provisioning server is within a geographic boundary of the deployment location, the process 200 can include provisioning computing assets in the current location for the requested computing service at stage 208. Upon completion of the provisioning operations, the process 200 can then proceed to transmitting a deployment report to, for instance, the directory server or service, at stage 210. In response to determining that the provisioning server is not within a geographic boundary of the deployment location, the process 200 can include forwarding the received request to another provisioning server that is within the geographic boundary of the deployment location. In certain embodiments, the other provisioning server can be identified from a list of provisioning servers within each geographic boundary. In other embodiments, the other provisioning server can be a default provisioning server pre-configured by, for instance, an administrator of the distributed computing system, when, for example, no provisioning server is identified within the geographic boundary of the deployment location. Upon receiving the forwarded request, the other provisioning server can then perform the receiving, determining, provisioning, and transmitting operations at stages 202, 204, 208, and 210 in response to the request from the user.

FIG. 4B is a flowchart illustrating example operations for determining a deployment location corresponding to a user. In the illustrated example, the operations can include querying a directory server for user account data at stage 222. In certain embodiments, the directory server can be configured to contain a database maintaining records of user account data. Querying the directory server can thus include querying the database of the user account data for at least the deployment location of the user. In other embodiments, querying the directory server can also include querying one or more geographic locations at which the user is allowed to deploy computing assets. The operations can then include receiving the user account data at stage 224 and determining the deployment location from the received user account data at stage 226.

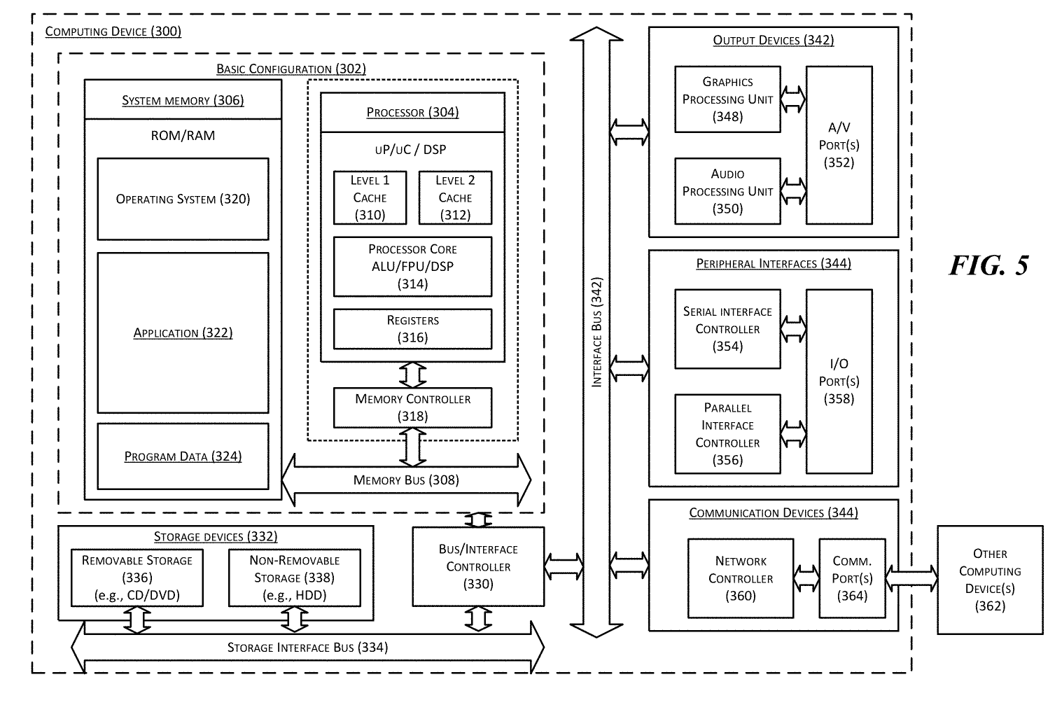

FIG. 5 is a computing device 300 suitable for certain components of the distributed computing system 100 in FIG. 1. For example, the computing device 300 can be suitable for the client devices 102, provisioning server 106, the directory server 112, or the web server 118 of FIG. 1. In a very basic configuration 302, the computing device 300 can include one or more processors 304 and a system memory 306. A memory bus 308 can be used for communicating between processor 304 and system memory 306.

Depending on the desired configuration, the processor 304 can be of any type including but not limited to a microprocessor (μP), a microcontroller (μC), a digital signal processor (DSP), or any combination thereof. The processor 304 can include one more levels of caching, such as a level-one cache 310 and a level-two cache 312, a processor core 314, and registers 316. An example processor core 314 can include an arithmetic logic unit (ALU), a floating point unit (FPU), a digital signal processing core (DSP Core), or any combination thereof. An example memory controller 318 can also be used with processor 304, or in some implementations memory controller 318 can be an internal part of processor 304.

Depending on the desired configuration, the system memory 306 can be of any type including but not limited to volatile memory (such as RAM), non-volatile memory (such as ROM, flash memory, etc.) or any combination thereof. The system memory 306 can include an operating system 320, one or more applications 322, and program data 324. This described basic configuration 302 is illustrated in FIG. 7 by those components within the inner dashed line.

The computing device 300 can have additional features or functionality, and additional interfaces to facilitate communications between basic configuration 302 and any other devices and interfaces. For example, a bus/interface controller 330 can be used to facilitate communications between the basic configuration 302 and one or more data storage devices 332 via a storage interface bus 334. The data storage devices 332 can be removable storage devices 336, non-removable storage devices 338, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data. The term “computer readable storage media” or “computer readable storage device” excludes propagated signals and communication media.

The system memory 306, removable storage devices 336, and non-removable storage devices 338 are examples of computer readable storage media. Computer readable storage media include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by computing device 300. Any such computer readable storage media can be a part of computing device 300. The term “computer readable storage medium” excludes propagated signals and communication media.

The computing device 300 can also include an interface bus 340 for facilitating communication from various interface devices (e.g., output devices 342, peripheral interfaces 344, and communication devices 346) to the basic configuration 302 via bus/interface controller 330. Example output devices 342 include a graphics processing unit 348 and an audio processing unit 350, which can be configured to communicate to various external devices such as a display or speakers via one or more A/V ports 352. Example peripheral interfaces 344 include a serial interface controller 354 or a parallel interface controller 356, which can be configured to communicate with external devices such as input devices (e.g., keyboard, mouse, pen, voice input device, touch input device, etc.) or other peripheral devices (e.g., printer, scanner, etc.) via one or more I/O ports 358. An example communication device 346 includes a network controller 360, which can be arranged to facilitate communications with one or more other computing devices 362 over a network communication link via one or more communication ports 364.

The network communication link can be one example of a communication media. Communication media can typically be embodied by computer readable instructions, data structures, program modules, or other data in a modulated data signal, such as a carrier wave or other transport mechanism, and can include any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), microwave, infrared (IR) and other wireless media. The term computer readable media as used herein can include both storage media and communication media.

The computing device 300 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 300 can also be implemented as a personal computer including both laptop computer and non-laptop computer configurations.

Specific embodiments of the technology have been described above for purposes of illustration. However, various modifications can be made without deviating from the foregoing disclosure. In addition, many of the elements of one embodiment can be combined with other embodiments in addition to or in lieu of the elements of the other embodiments. Accordingly, the technology is not limited except as by the appended claims.

I/We claim:

1. A method for geographic location based computing asset provisioning in a distributed computing system, the method including:
receiving, at a provisioning server in the distributed computing system and via a computer network, a request from a user to deploy a computing service in the distributed computing system;
identifying, at the provisioning server, a pre-configured deployment location at which the user is allowed to deploy computing assets for providing the requested computing service;
determining whether the pre-configured deployment location matches a geographic location of the provisioning server; and
in response to determining that the pre-configured deployment location does not match the geographic location of the provisioning server, forwarding, via the computer network, the received request from the user to another provisioning server corresponding to the identifying deployment location, thereby allowing the another provisioning server to provision the computing assets for the user in the pre-configured deployment location to satisfy data residency regulations.

2. The method of claim 1, further comprising:
in response to determining that the pre-configured deployment location matches the geographic location of the provisioning server,
provisioning the computing assets in the geographic location at which the provisioning server is located; and
upon a completion of provisioning the computing assets for the requested computing service, transmitting, via the computer network, a deployment report to a directory server to track a geographic location at which the computing assets are deployed for the user.

3. The method of claim 1, further comprising:
in response to determining that the pre-configured deployment location matches the geographic location of the provisioning server,
provisioning the computing assets in the geographic location at which the provisioning server is located; and
upon a completion of provisioning the computing assets for the requested computing service, notifying, via the computer network, one or more additional provisioning servers in the distributed computing system regarding a geographic location at which the computing assets are deployed for the user.

4. The method of claim 1 wherein identifying the pre-configured deployment location includes:
transmitting, via the computer network, a query to a directory server containing records of user account data;
receiving, from the directory server, a query result containing the user account data of the user requesting the computing service; and
determining the pre-configured deployment location from the received query result.

5. The method of claim 1 wherein:
the geographic location of the provisioning server includes a physical address; and
determining whether the pre-configured deployment location matches the geographic location of the provisioning server includes comparing the physical address of the provisioning server to the pre-configured deployment location to determine whether the physical address is within the geographic boundary of the deployment location.

6. The method of claim 1 wherein:
the provisioning server contains data identifying a corresponding geographic boundary of a city, state, region, or country; and
determining whether the pre-configured deployment location matches the geographic location of the provisioning server includes comparing the geographic boundary of the provisioning server to the pre-configured deployment location to determine whether the geographic boundary is within that of the deployment location.

7. The method of claim 1, further comprising:
in response to determining that the pre-configured deployment location does not match the geographic location of the provisioning server,
determining whether a provisioning server is available within a geographic boundary of the pre-configured deployment location; and
in response to determining that a provisioning server is available within the geographic boundary of the pre-configured deployment location,
selecting the provisioning server as the another provisioning server; and
forwarding the received request from the user to the another provisioning server within the geographic boundary of the pre-configured deployment location, thereby allowing the another provisioning server to provision the computing assets for the requested computing service.

8. The method of claim 1, further comprising:
in response to determining that the pre-configured deployment location does not match the geographic location of the provisioning server,
determining whether the another provisioning server is available within a geographic boundary of the pre-configured deployment location; and
in response to determining that a provisioning server is not available within the geographic boundary of the pre-configured deployment location,
selecting a default provisioning server as the another provisioning server; and
forwarding the received request from the user to the default provisioning server, thereby allowing the default provisioning server to provision the computing assets for the requested computing service.

9. The method of claim 1 wherein:
receiving the request includes receiving the request by the distributed computing system at a geographic location; and
the method further includes deploying the computing assets at the pre-configured deployment location that is different than the geographic location.

10. A provisioning server configured for geographic location based computing asset provisioning in a distributed computing system, the provisioning server including:
a processor; and
a memory operatively coupled to the processor, the memory containing instructions executable by the processor to cause the provisioning server to, upon receiving a request to deploy a computing service in the distributed computing system from a user,
retrieve, from a directory service, a record of user account data containing data representing a pre-configured deployment location at which user data of the requested computing service is to be stored;
determine whether a current geographic location of the provisioning server is within a geographic boundary of the deployment location; and
in response to determining that the current geographic location of the provisioning server is within a geographic boundary of the deployment location, deploy computing assets at the current geographic location in response to the requested computing service, thereby allowing user data of the computing service to be stored at the pre-configured deployment location to satisfy data residency regulations.

11. The provisioning server of claim 10 wherein the memory contains additional instructions executable by the processor to cause the provisioning server to:
in response to determining that the current geographic location of the provisioning server is not within a geographic boundary of the deployment location,
select another provisioning server based on the deployment location of the user; and
forward a copy of the received request to the selected another provisioning server.

12. The provisioning server of claim 10 wherein the memory contains additional instructions executable by the processor to cause the provisioning server to:
in response to determining that the current geographic location of the provisioning server is not within a geographic boundary of the deployment location,
select another provisioning server based on the deployment location of the user, the selected another provisioning server is within a geographic boundary of the deployment location; and
forward a copy of the received request to the selected another provisioning server.

13. The provisioning server of claim 10 wherein the memory contains additional instructions executable by the processor to cause the provisioning server to:
in response to determining that the current geographic location of the provisioning server is not within a geographic boundary of the deployment location,
determine whether another provisioning server is available within the geographic boundary of the deployment location;
in response to determining that another provisioning server is not available within the geographic boundary of the deployment location, forward a copy of the received request to a default provisioning server.

14. The provisioning server of claim 10 wherein:
the current geographic location of the provisioning server includes a physical address; and
to determine whether the current geographic location of the provisioning server is within the geographic boundary of the deployment location includes comparing the physical address of the provisioning server to the pre-configured deployment location to determine whether the physical address is within the geographic boundary of the deployment location

15. The provisioning server of claim 10 wherein:
the current geographic location of the provisioning server includes a city, state, region, or country; and
to determine whether the current geographic location of the provisioning server is within the geographic boundary of the deployment location includes to determine whether the city, state, region, or country is within the geographic boundary of the deployment location.

15. The provisioning server of claim 10 wherein to deploy the computing assets includes to deploy the computing assets at the pre-configured deployment location irrespective of a geographic location at which the request is received from the user.

17. A method for geographic location based computing asset provisioning in a distributed computing system, the method including:
receiving, from a user and via a computer network, a request to deploy a computing service in the distributed computing system;
determining a pre-configured deployment location for deploying computing assets for providing the requested computing service, the pre-configured deployment location having a geographic boundary within which user data of the computing service is to be stored; and
based on the determined pre-configured deployment location, deploying the computing assets within the geographic boundary of the pre-configured deployment location in the distributed computing system irrespective of a geographic location at which the request is received from the user, thereby allowing the another provisioning server to provision the computing assets for the user in the pre-configured deployment location to satisfy data residency regulations.

18. The method of claim 17 wherein deploying the computing assets includes:
determining whether the geographic location at which the request is received from the user is within the geographic boundary of the pre-configured deployment location; and
in response to determining that the geographic location at which the request is received from the user is within the geographic boundary of the pre-configured deployment location, deploying the computing assets within the geographic boundary of the geographic location at which the request is received from the user.

19. The method of claim 17 wherein deploying the computing assets includes:
determining whether the geographic location at which the request is received from the user is within the geographic boundary of the pre-configured deployment location; and
in response to determining that the geographic location at which the request is received from the user is not within the geographic boundary of the pre-configured deployment location,
determining whether a provisioning server is available within the geographic boundary of the pre-configured deployment location; and
in response to determining that a provisioning server is available within the geographic boundary of the pre-configured deployment location, transmitting a copy of the received request to the provisioning server, thereby allowing the provisioning server to deploy the computing assets within the geographic boundary of pre-configured deployment location.

18. The method of claim 17 wherein deploying the computing assets includes:
determining whether the geographic location at which the request is received from the user is within the geographic boundary of the pre-configured deployment location; and
in response to determining that the geographic location at which the request is received from the user is within the geographic boundary of the pre-configured deployment location,
determining whether a provisioning server is available within the geographic boundary of the pre-configured deployment location; and
in response to determining that a provisioning server is not available within the geographic boundary of the pre-configured deployment location, transmitting a copy of the received request to a default provisioning server, thereby allowing the default provisioning server to deploy the computing assets in response to the request from the user.
